(19) United States
(12) Patent Application Publication
(10) Pub. No.: US 2025/0012961 A1
(43) Pub. Date: Jan. 9, 2025

(54) PATTERNED THIN FILMS AS ANTI-REFLECTION COATINGS FOR AUGMENTED REALITY WAVEGUIDE COMBINERS

(71) Applicant: Applied Materials, Inc., Santa Clara, CA (US)

(72) Inventors: Evan WANG, Palo Alto, CA (US); Kunal SHASTRI, Santa Clara, CA (US); David Alexander SELL, Santa Clara, CA (US); Kevin MESSER, Mountain View, CA (US); Samarth BHARGAVA, Saratoga, CA (US)

(21) Appl. No.: 18/747,844

(22) Filed: Jun. 19, 2024

Related U.S. Application Data
(60) Provisional application No. 63/525,008, filed on Jul. 5, 2023.

(51) Int. Cl. F21V 8/00; G02B 5/18

(52) U.S. Cl. CPC G02B 6/0016; G02B 5/1809; G02B 6/0036; G02B 6/0065

(57) ABSTRACT

A waveguide is disclosed. The waveguide includes one or more gratings disposed over a substrate. The gratings include grating structures having a grating pitch. The waveguide includes a waveguide region disposed over the substrate between each grating and an edge of the substrate. The waveguide region includes auxiliary structures with an auxiliary pitch less than the grating pitch.

### CROSS-REFERENCE TO RELATED APPLICATIONS

This application claims priority to U.S. Provisional Patent Application Ser. No. 63/525,008 filed on Jul. 5, 2023, which is herein incorporated by reference in its entirety.

### BACKGROUND

### Field

Embodiments of the present disclosure generally relate to waveguide combiners for augmented, virtual, and mixed reality. More specifically, embodiments described herein provide waveguides having auxiliary structures between one or more gratings and methods of fabrication.

### Description of the Related Art

Virtual reality is generally considered to be a computer generated simulated environment in which a user has an apparent physical presence. A virtual reality experience can be generated in 3D and viewed with a head-mounted display (HMD), such as glasses or other wearable display devices that have near-eye display panels as lenses to display a virtual reality environment that replaces an actual environment.

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality

Augmented reality, however, enables an experience in which a user can still see through the display lenses of the glasses or other HMD device to view the surrounding environment, yet also see images of virtual objects that are generated for display and appear as part of the environment. Augmented reality can include any type of input, such as audio and haptic inputs, as well as virtual images, graphics, and video that enhance or augment the environment that the user experiences. As an emerging technology, there are many challenges and design constraints with augmented reality. Accordingly, what is needed in the art are waveguides having auxiliary structures between one or more gratings.

### SUMMARY

The present disclosure generally relates to waveguides, including waveguides with gratings having a grating pitch and auxiliary structures having an auxiliary pitch.

In one embodiment, a waveguide includes one or more gratings disposed over a substrate. The gratings include grating structures having a grating pitch. The waveguide includes a waveguide region disposed over the substrate between each grating and an edge of the substrate. The waveguide region includes auxiliary structures with an auxiliary pitch less than the grating pitch.

In one embodiment, a method includes disposing a structure material over a surface of a substrate. The method includes forming a patterned photoresist over the structure material. The patterned photoresist is disposed over a grating region and a waveguide region between the grating region and an edge of the substrate. Each grating region and each waveguide region exposes unmasked portions of the structure material. The method includes etching the unmasked portions of structure material layer. Etching the unmasked portions forms a grating having grating structures with a grating pitch, and auxiliary structures with an auxiliary pitch less than the grating pitch.

In one embodiment, a method includes imprinting a stamp into a structure material layer disposed over a surface of a substrate. The method includes curing the structure material layer to form a grating having grating structures with a grating pitch, and auxiliary structures with an auxiliary pitch that is less than the grating pitch.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments of the present disclosure and are therefore not to be considered limiting of its scope, and may admit to other equally effective embodiments.

FIG. 1A is a schematic, top view of a waveguide according to embodiments described herein.

FIG. 1B is a cross-sectional view of a portion of a waveguide according to embodiments described herein.

FIGS. 2A and 2B are schematic, cross-sectional views of a substrate during a first method according to embodiments described herein.

FIGS. 3A and 3B are schematic, cross-sectional views of substrate during a second method according to embodiments described herein.

FIG. 4A is a schematic, top sectional view of a portion of a waveguide according to embodiments described herein.

FIG. 4B is a k-space diagram representative of a waveguide according to embodiments described herein.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

Embodiments of the present disclosure generally relate to waveguides for augmented, mixed, or virtual reality. Specifically, embodiments described herein provide for waveguides having auxiliary structures between one or more gratings and methods of fabrication.

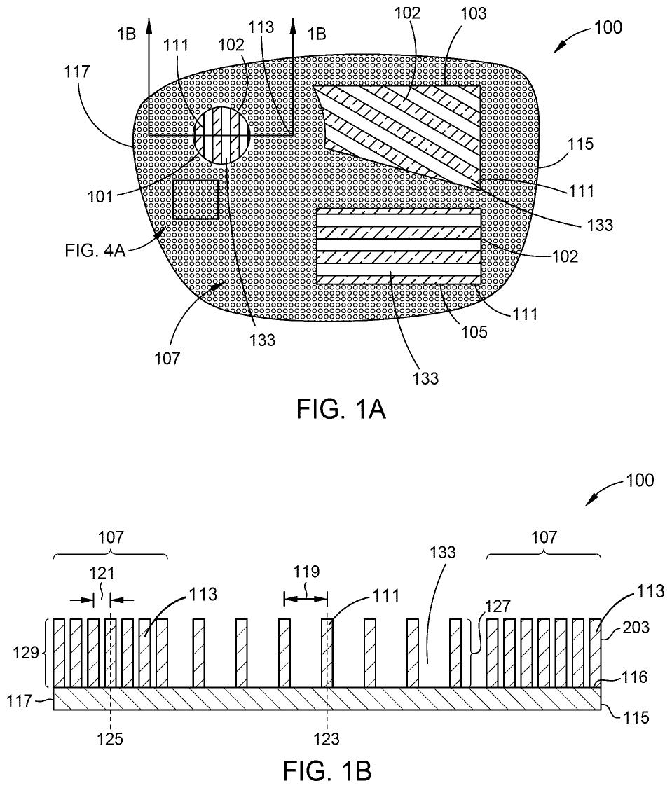

FIG. 1A is a schematic, top view of a waveguide 100. FIG. 1B is a cross-sectional view of a portion of the waveguide 100. The waveguide 100 includes one or more gratings 102 disposed over a substrate 115. The substrate 115 may include substrates of any suitable material, including, but not limited to, amorphous dielectrics, non-amorphous dielectrics, crystalline dielectrics, silicon-containing materials, polymers, and combinations thereof.

In one embodiment, which can be combined with other embodiments described herein, the substrate 115 consists of one or more of silicon (Si), silicon dioxide (SiO₂), silicon carbide (SiC), fused silica, diamond, or quartz materials. In some embodiment, which can be combined with other embodiments described herein, the substrate 115 includes of one or more of nitrogen, titanium, niobium, lanthanum, zirconium, or yttrium containing-materials. The substrate 115 may include optical material having a refractive index of about 2, e.g., about 1.7 to 2.3, about 1.8 to 2.2, about 1.9 to 2.1, or about 2.0 to 2.1.

The one or more gratings 102 include an input coupler 101, a pupil expander 103, and an output coupler 105. The gratings 102 include grating structures 111. The gratings 102 are one-dimensional gratings. I.e., the grating structures 111 extend across the entirety of the grating region with gaps 133 there between. The waveguide 100 also includes a waveguide region 107 between the one or more gratings 102. The waveguide region 107 includes auxiliary structures 113. The auxiliary structures 113 are disposed in a two-dimensional array in the waveguide region 107. Gaps 135 surround the auxiliary structures 113.

The grating structures 111 have a grating pitch 119. The grating pitch 119 is a distance between centers 123 of adjacent grating structures 111. The center 123 is the center of the grating structures 111 where the grating structures 111 contact the substrate 115. The grating pitch 119 may be about 10 nanometers (nm) and about 200 nm. The grating structures 111 include a grating depth 127. The grating depth 127 is the distance the grating structures 111 extend from the top surface 116 of the substrate 115. The grating depth 127 is between about 10 nm and 1000 nm. The grating structures 111 include a ratio of grating pitch 119 to the grating depth 127. For example, the pitch to depth ratio of the grating pitch 119 to the grating depth 127 is from 10:1 to 1:10. In yet another example the pitch to depth ratio of the grating pitch 119 to the grating depth 127 is from 2:1 to 4:1. The grating depth 127 and grating pitch 119 of the grating structures 111 of the input coupler 101 may be different than the grating depth 127 and grating pitch 119 of the pupil expander 103 or an output coupler 105.

The grating structures 111 include a structure material 203. In some embodiments, the structure material 203 has a refractive index greater than 2.0. In some embodiments, the structure material 203 includes imprintable materials with a refractive index range of about 1.1 to about 3.5. The structure material 203 includes, but is not limited to, one or more of silicon carbide (SiC), silicon oxycarbide (SiOC), titanium dioxide (TiO₂), SiO₂, vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), or silicon carbon-nitride (SiCN) containing materials.

The waveguide 100 also includes a waveguide region 107. The waveguide region 107 is disposed on the substrate 115. The waveguide region 107 is disposed between each grating 102 and an edge 117 of the substrate 115.

In operation, the input coupler 101 receives incident beams of light (a virtual image) having an intensity from a microdisplay (not shown). The incident beams of light undergo total internal reflection (TIR) and propagate in the waveguide 100 in order to direct the virtual image to the pupil expander 103. The incident beams of light continue under TIR and propagate in the waveguide 100 in order to direct the virtual image to the output coupler 105 where the incident beams of light are out-coupled to the user. As the incident beams of light propagate in TIR in the waveguide 100, some of the beams of light will be incident on the input coupler 101, and the output coupler 105, while some of the beams of light will be incident on areas of the substrate 115 adjacent thereto. The areas are a waveguide region 107 disposed over the substrate 115 between each grating 102 and an edge 117 of the substrate 115.

The waveguide region 107 in prior implementations included the structure material 203 disposed thereover. The structure material 203 of a high refractive index, e.g. a refractive index greater than 2.0, decreases visibility of users' eyes from the world perspective. The high reflectivity may also cause distracting reflections of the scene behind the user to into the user's field of view. Here, the waveguide region 107 has auxiliary structures 113. The auxiliary structures 113 surround a respective grating 102. The auxiliary structures 113 include the structure material 203. The structure material 203 of the auxiliary structures 113 is the same as the structure material 203 of the grating structures 111. The auxiliary structures 113 are disposed in a two-dimensional array in the waveguide region 107. Gaps 135 surround auxiliary structures 113. The auxiliary structures 113 have an auxiliary pitch 121 less than the grating pitch 119. The auxiliary pitch 121 less than the grating pitch 119 allows the grating structures 111 to diffract light without interference from the auxiliary structures 113. The auxiliary structures 113 further reflection into the user's field of view by preventing diffraction of light already in total internal reflection (TIR). The auxiliary pitch 121 is a distance between centers 125 of adjacent auxiliary structures 113. The center 125 is the center of the auxiliary structures 113 where the auxiliary structures 113 contact the substrate 115. The auxiliary pitch 121 may be about 10 nm and about 200 nm. The auxiliary structures 113 include an auxiliary depth 129. The auxiliary depth 129 is the distance the auxiliary structures 113 extend from the top surface 116 of the substrate 115. The auxiliary depth 129 is between about 10 nm and 1000 nm. The auxiliary structures 113 may be different shapes. The auxiliary structure 113 shapes may include cylindrical shape, a rectangular shape, a hexagonal pillar shape, a cone shape, one dimensional grating line shape cylinders, rectangular cubes, hexagonal pillars, cones, or combinations thereof. In some embodiments, the grating structures 111 in the waveguide region 107 are shaped differently than the auxiliary structures 113 in the waveguide region 107. In some embodiments, the auxiliary structures 113 are sized and shaped to maintain a characteristic of a light passed through the substrate 115. In some embodiments, the depth 127 of the grating structures 111 and the depth 129 of the auxiliary structures 113 are different. As shown in FIG. 1B, the depth 127 of the grating structures 111 and the depth 129 of the auxiliary structures 113 are the same. The auxiliary structures 113 are disposed over at least 20% of the top surface 116 of the waveguide 100.

The auxiliary structures 113 include the structure material 203. The auxiliary structures 113 and the grating structures 111 both include the structure material 203. While the grating structures 111 and the auxiliary structures 113 may have different compositions of the structure material 203, the grating structures 111 and the auxiliary structures 113 having the same composition of the structure material 203 allows the auxiliary structures 113 and the grating structures 111 to be fabricated concurrently. Methods disclosed herein provide for methods of fabrication where the auxiliary structures 113 and the grating structures 111 are fabricated concurrently.

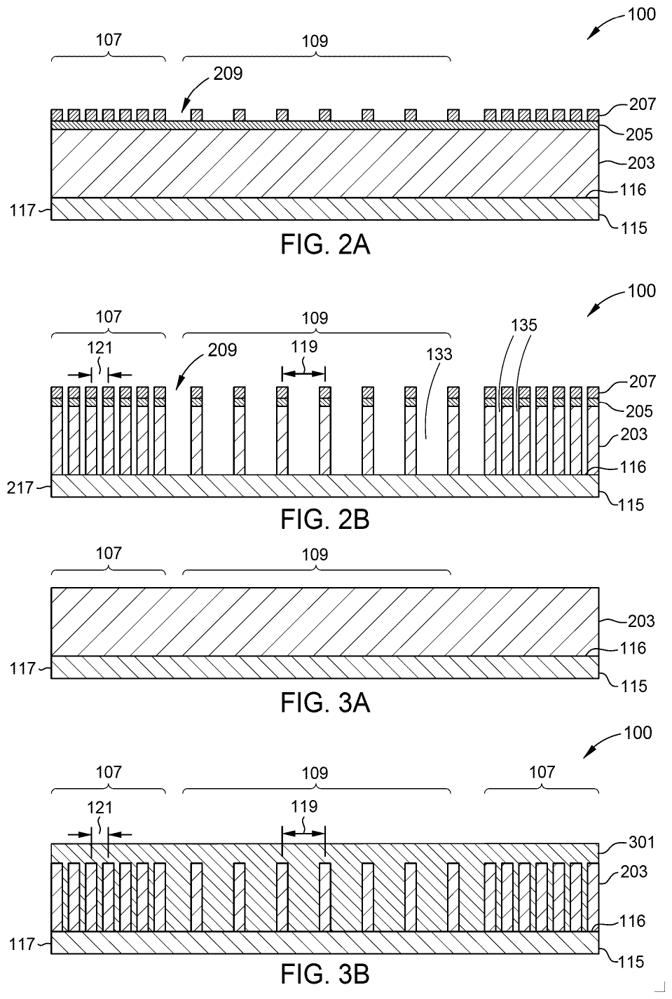

FIGS. 2A and 2B are schematic, cross-sectional views of a substrate 115 during a first method. In a first operation of the first method, as shown in FIG. 2A, the structure material 203 is disposed over the substrate 115. An etch layer 205 is disposed over the structure material 203. A photoresist 207 is disposed over the structure material 203. The photoresist 207 is patterned. The patterned photoresist 207 is disposed over at least one grating region 109 and at least one waveguide region 107. The patterned photoresist 207 is disposed between the at least one grating region 109 and an edge 117 of the substrate 115.

Each grating region 109 and each waveguide region 107 have exposed unmasked portions 209 of the structure material layer 203. The photoresist 207 is not disposed over unmasked portions 209 of the layer of structure material 203. The pattern of the photoresist 207 over the waveguide region 107 will determine the auxiliary pitch 121 of the auxiliary structures 113. The pattern of the photoresist 207 over the grating region 109 will determine the grating pitch 119 of the grating structures 111.

In a second operation of the first method, as shown in FIG. 2B, the structure material 203 is etched. Etching the structure material 203 includes etching the unmasked portions 209 of structure material 203 layer to simultaneously form at least one grating 102 having grating structures 111 with a grating pitch 119 and auxiliary structures 113 with an auxiliary pitch 121 less than the grating pitch 119.

FIGS. 3A and 3B are schematic, cross-sectional views of a substrate 115 during a second method. In a first operation of the second method, as shown in FIG. 3A, a structure material 203 is disposed over the surface 116 of the substrate 115.

In a second operation of the second method, as shown in FIG. 3B, a stamp 301 is imprinted into the structure material 203. The stamp 301 is molded from a master and may be made from a semi-transparent material, such as fused silica or polydimethylsiloxane (PDMS) material, or a transparent material, such as glass, to allow the structure material 203 to be cured by exposure to radiation, such as infrared (IR) radiation or ultraviolet (UV) radiation. In one embodiment, the stamp 301 comprises a rigid backing sheet, such as a sheet of glass, to add mechanical strength to the stamp 301.

In a third operation of the second method, the structure material 203 is cured. The curing forms one or more gratings 102. The gratings 102 include grating structures 111. The grating structures 111 include the grating pitch 119. The grating structures 111 are disposed on the surface 116 of the substrate 115. The curing also forms auxiliary structures 113. The auxiliary structures 113 include an auxiliary pitch 121. The auxiliary structures 113 are disposed on the surface 116 of the substrate 115. The waveguide region 107 is disposed between the one or more gratings 102 and an edge 117 of the substrate 115. The waveguide region 107 has auxiliary structures 113 with an auxiliary pitch 121 less than the grating pitch 119.

The stamp 301 is released. The resulting waveguide 100 includes the gratings 102 that correspond to the grating structures 111 and the auxiliary structures 113. In one embodiment, grating structures 111 are on the grating region 109 of the substrate 115 that corresponds to the input coupler 101, the pupil expander 103, and the output coupler 105 of the waveguide 100.

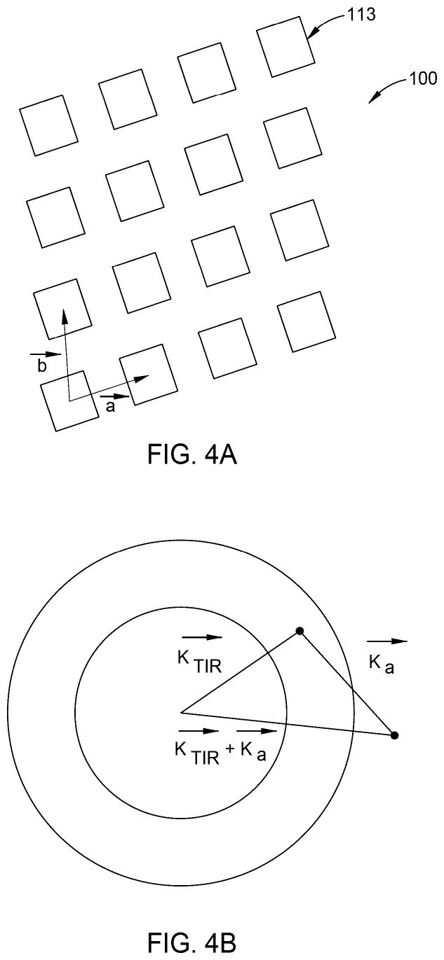

FIG. 4A is a schematic, top sectional view of a portion of a waveguide according to embodiments described herein. FIG. 4B is a k-space diagram representative of a waveguide according to embodiments described herein. The auxiliary structures 113, as shown in FIG. 4A, are defined by lattice vectors [symbol] and [symbol] . For one dimensional structures, [symbol] =0. The auxiliary structures 113 include normalized k-vectors.

In the following equation,

$$\vec{{k}_{a}} = 2 π \frac{{R}_{90} \vec{b}}{\vec{a} \cdot {R}_{90} \vec{b}} , \vec{{k}_{a}}$$

is the k-vector for vector [symbol] . In the following equation,

$$\vec{{k}_{b}} = 2 π \frac{{R}_{90} \vec{a}}{\vec{b} \cdot {R}_{90} \vec{a}} , \vec{{k}_{b}}$$

is the k-vector for vector [symbol] . R₉₀ is a 90-degree rotation matrix

$$[ \begin{matrix}0 & - 1 \\ 1 & 0\end{matrix} ] .$$

Light in TIR traveling in the waveguide 100 includes a wavelength λ. The light in the waveguide 100 also includes a k-vector of \vec{k_{TIR}}.

For the light in the waveguide 100 to not diffract, the following criteria must be met:

$$\vert \vec{{k}_{TIR}} + m \vec{{k}_{a}} \vert > \frac{2 π}{λ} {n}_{sub} and \vert \vec{{k}_{TIR}} + m \vec{{k}_{b}} \vert > \frac{2 π}{λ} {n}_{sub} .$$

Here, m is a non-zero integer and n_{sub} is the substrate refractive index. This enables the waveguide 100 to maintain light in TIR without decreasing visibility of users' eyes or causing distracting reflections.

In summation, methods of fabricating waveguides with gratings having different gratings with different pitches are described herein. The etching method of fabrication and the imprinting method of fabrication enable a single fabrication process to cover the substrate. These waveguides and fabrication methods allow for faster production and minimization of high reflection regions between specific gratings. For example, highly reflective auxiliary structures decrease visibility. By making the pitch of the auxiliary structures less than the grating structures, other light does not cause distracting reflections and avoiding diffraction within TIR.

While the foregoing is directed to examples of the present disclosure, other and further examples of the disclosure may be devised without departing from the basic scope thereof, and the scope thereof is determined by the claims that follow.

What is claimed is:

1. A waveguide, comprising:
one or more gratings disposed over a substrate, each grating comprising grating structures having a grating pitch; and
a waveguide region disposed over the substrate between each grating and an edge of the substrate, the waveguide region having auxiliary structures with an auxiliary pitch less than the grating pitch.

2. The waveguide of claim 1, wherein the grating pitch is a distance between a center of adjacent grating structures.

3. The waveguide of claim 1, wherein the one or more gratings further comprise a depth, the depth being 10 nanometers or greater.

4. The waveguide of claim 3, wherein the one or more gratings further comprise a pitch to depth ratio of about 1:1 to about 1:5.

5. The waveguide of claim 1, wherein the auxiliary structures comprise one or more of silicon carbide (SiC), silicon oxycarbide (SiOC), titanium dioxide (TiO₂), SiO₂, vanadium (IV) oxide (VOx), aluminum oxide (Al₂O₃), aluminum-doped zinc oxide (AZO), indium tin oxide (ITO), tin dioxide (SnO₂), zinc oxide (ZnO), tantalum pentoxide (Ta₂O₅), silicon nitride (Si₃N₄), zirconium dioxide (ZrO₂), niobium oxide (Nb₂O₅), cadmium stannate (Cd₂SnO₄), silicon mononitride (SiN), silicon oxynitride (SiON), barium titanate (BaTiO₃), diamond like carbon (DLC), hafnium(IV) oxide (HfO₂), lithium niobate (LiNbO₃), or silicon carbon-nitride (SiCN).

6. The waveguide of claim 1, wherein the auxiliary structures comprise a refractive index of about 1.5 to 2.0.

7. The waveguide of claim 1, wherein a refractive index of the substrate is about 1.5 to 2.0.

8. The waveguide of claim 1, wherein the auxiliary structures surround a respective grating.

9. The waveguide of claim 8, wherein the grating structures in the waveguide region are shaped differently than the auxiliary structures in the waveguide region.

10. A method, comprising:
disposing a structure material over a surface of a substrate;
forming a patterned photoresist over the structure material, the patterned photoresist disposed over:
a grating region; and
a waveguide region between the grating region and an edge of the substrate, wherein each grating region and each waveguide region exposes unmasked portions of the structure material; and
etching the unmasked portions of structure material layer, wherein the etching the unmasked portions form:
a grating comprising grating structures with a grating pitch; and
auxiliary structures with an auxiliary pitch less than the grating pitch.

11. The method of claim 10, wherein the grating pitch is a distance between a center of each adjacent grating structures.

12. The method of claim 10, wherein etching the unmasked portions simultaneously forms the grating structures disposed in the grating region and the auxiliary structures disposed in the waveguide region.

13. The method of claim 10, wherein a shape of the auxiliary structures is one of a cylindrical shape, a rectangular shape, a hexagonal pillar shape, a cone shape, or an one dimensional grating line shape.

14. A method, comprising:
imprinting a stamp into a structure material layer disposed over a surface of a substrate;
curing the structure material layer to form:
a grating comprising grating structures having a grating pitch; and
auxiliary structures with an auxiliary pitch less than the grating pitch.

15. The method of claim 14, wherein the auxiliary structures are sized and shaped to maintain a characteristic of a light passed through the substrate.

16. The method of claim 14, wherein the grating structures are disposed in a grating region and the auxiliary structures are disposed in a waveguide region around the grating region.

17. The method of claim 14, wherein the grating structures and the auxiliary structures have the same composition.

18. The method of claim 16, wherein a refractive index of the waveguide region is greater than a refractive index of the grating region.

19. The method of claim 14, wherein a shape of the grating structures is one of a cylindrical shape, a rectangular shape, a hexagonal pillar shape, a cone shape, or an one dimensional grating line shape.

20. The method of claim 19, wherein the grating structures in a grating region are shaped differently than the auxiliary structures in a waveguide region.
